(19) United States
(12) Patent Application Publication
(10) Pub. No.: US 2013/0300769 A1
(43) Pub. Date: Nov. 14, 2013

(54) IMAGE ROTATION CONTROL METHOD AND DEVICE

(71) Applicant: Huawei Technologies Co., Ltd., (US)

(72) Inventors: Jun HUANG, Shanghai (CN); Xiao XIAO, Shanghai (CN)

(21) Appl. No.: 13/870,663

(22) Filed: Apr. 25, 2013

(30) Foreign Application Priority Data
Apr. 26, 2012 (CN) 201210126351.8

(51) Int. Cl. G09G 5/00

(52) U.S. Cl. CPC G09G 5/00
USPC 345/658; 345/649

(57) ABSTRACT

Embodiments of the present invention disclose an image rotation control method and device. The method includes: reading image blocks of a first image from a first buffer according to a rotation angle, where the first image is in a first image format; writing the read image blocks into a preset second buffer; and reading image data from the second buffer according to a second image format, so as to obtain a rotated second image.

### CROSS-REFERENCE TO RELATED APPLICATION

This application claims priority to Chinese Patent Application No. 201210126351.8, filed on Apr. 26, 2012, which is hereby incorporated by reference in its entirety.

### FIELD OF THE INVENTION

The present invention relates to the field of image processing technologies, and in particular, to an image rotation control method and device.

### BACKGROUND OF THE INVENTION

When playing a video or performing game application, an existing mobile terminal may utilize gravity sensing to rotate a display screen in real time according to a direction in which the terminal is held, so as to obtain application experience of different angles. For performing a real-time rotation operation on a display screen, a terminal is required to have high DDR (Double Data Rate, double data rate synchronous dynamic random access memory) bandwidth.

An existing display rotation process includes: A GPU (Graphic Processing Unit, graphic processing unit) in a terminal converts an image originally of a Tile format in a DDR into an image of a Linear format, and rotates the image of the Linear format in the DDR by a corresponding angle, and then sends the rotated image to an LCD (Liquid Crystal Display, liquid crystal display) for display. In a process of studying the prior art, the inventor finds that, in a process of performing format conversion on an image, rotating the image by an angle, and sending the image to the LCD, because read/write operations are performed on the DDR in multiple times and system bandwidth needs to be occupied in each read/write operation, a large demand for the system bandwidth in a terminal exists in the existing display rotation process, and correspondingly, effective bandwidth that can be obtained by other functional modules in the terminal are occupied, and if the system bandwidth is increased to satisfy the bandwidth demand for display rotation, not only the costs of the terminal are increased, but also the system power consumption of the terminal is increased.

### SUMMARY OF THE INVENTION

Embodiments of the present invention provide an image rotation control method and device, so as to solve the problem of occupying system bandwidth in an image rotation control process in the prior art.

To solve the foregoing technical problem, the embodiments of the present invention disclose the following technical solutions:

An image rotation control method is provided, where the method includes:
reading image blocks of a first image from a first buffer according to a rotation angle, where the first image is in a first image format;
writing the read image blocks into a preset second buffer; and
reading image data from the second buffer according to a second image format, so as to obtain a rotated second image.

An image rotation control device is provided, where the device includes:
a first read unit, configured to read image blocks of a first image from a first buffer according to a rotation angle, where the first image is in a first image format;
a write unit, configured to write the read image blocks into a preset second buffer; and
a second read unit, configured to read image data from the second buffer according to a second image format, so as to obtain a rotated second image.

In the embodiments of the present invention, the image blocks of the first image in the first image format are read from the first buffer according to the rotation angle, the read image blocks are written into the preset second buffer, and the image data is read from the second buffer according to the second image format, so as to obtain the rotated second image. According to the embodiments of the present invention, in a process of performing rotation control on an image, a read operation needs to be performed on the first buffer only once, so that the image data of the first image format is rotated to generate the image data of the second image format; therefore, compared with the prior art, in the rotation control process, the occupancy of system bandwidth in a terminal is reduced, other functional modules can obtain effective bandwidth in a situation that the bandwidth of the terminal is limited, and meanwhile the system power consumption is not wasted for increasing the system bandwidth.

### BRIEF DESCRIPTION OF THE DRAWINGS

To describe the technical solutions in the embodiments of the present invention more clearly, the following briefly introduces the accompanying drawings required for describing the embodiments. Apparently, persons of ordinary skill in the art may still derive other drawings from these accompanying drawings without any creative efforts.

FIG. 1 is a flow chart of a first embodiment of an image rotation control method according to the present invention;

FIG. 2A is a schematic diagram of a Tile format image according to an embodiment of the present invention;

FIG. 2B is a schematic diagram of a Linear format image according to an embodiment of the present invention;

FIG. 3A is a flow chart of a second embodiment of an image rotation control method according to the present invention;

FIG. 3B is a schematic diagram of a process of reading Tile image blocks from a DDR and writing the Tile image blocks into a rotation Buffer in FIG. 3A;

FIG. 3C is a schematic diagram of a process of reading a Linear format image from the rotation Buffer in FIG. 3B;

FIG. 4A is a flow chart of a third embodiment of an image rotation control method according to the present invention;

FIG. 4B is a schematic diagram of a process of reading Tile image blocks from a DDR and writing the Tile image blocks into a rotation Buffer in FIG. 4A;

FIG. 5A is a flow chart of a fourth embodiment of an image rotation control method according to the present invention;

FIG. 5B is a schematic diagram of a process of reading Tile image blocks from a DDR and writing the Tile image blocks into a rotation Buffer in FIG. 5A;

FIG. 6 is a block diagram of a first embodiment of an image rotation control device according to the present invention; and

FIG. 7 is a block diagram of a second embodiment of an image rotation control device according to the present invention.

### DETAILED DESCRIPTION OF THE EMBODIMENTS

The following embodiments of the present invention provide an image rotation control method and device.

To make the technical solutions in the embodiments of the present invention more comprehensible for persons skilled in the art, and make the foregoing objectives, features, and advantages of the embodiments of the present invention more clearly, the following further describes the technical solutions in the embodiments of the present invention in detail with reference to the accompanying drawings.

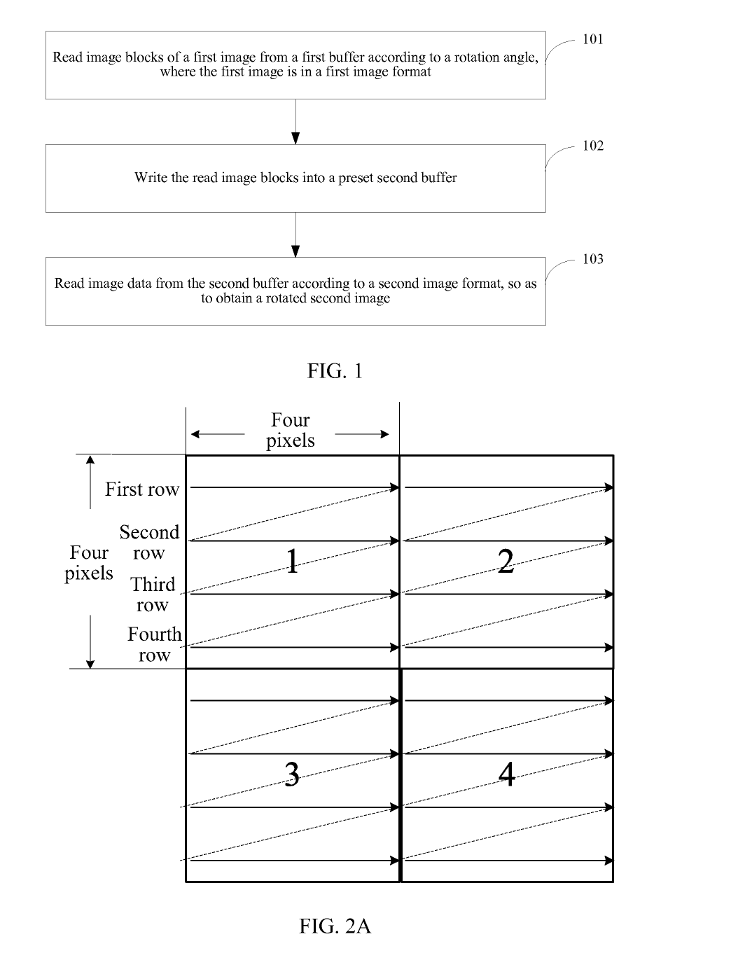

Referring to FIG. 1, FIG. 1 is a flow chart of a first embodiment of an image rotation control method according to the present invention:

Step 101: Read image blocks of a first image from a first buffer according to a rotation angle, where the first image is in a first image format.

According to different rotation angles, in the embodiment of the present invention, image rotation control generally refers to rotating an image by 90 degrees, 270 degrees, or 180 degrees.

When the first image format specifically is a Tile format, Tile image blocks of the first image may be read from the first buffer in a Burst (burst transmission) manner in sequence according to a rotation angle, where the Burst manner refers to a manner for reading an image having pixel addresses being continuous, and because pixel addresses of each Tile image block are continuous, the Tile image blocks may be read in a Burst manner.

In this step, at least one column of image blocks or one row of image blocks of the first image may be read from the first buffer each time. Correspondingly, a corresponding space size of a second buffer is set according to different numbers of columns or rows of image blocks of the first image which are read each time.

Step 102: Write the read image blocks into a preset second buffer.

When the first image format specifically is the Tile format, the read Tile image blocks are written into the second buffer in sequence from left to right. The second buffer may be formed of at least one pair of ping-pong buffers, and each buffer in each pair of ping-pong buffers is configured to store one column of Tile image blocks or one row of Tile image blocks of the first image. Besides adopting a ping-pong buffer as a specific form of the second buffer, in an image rotation control process that does not have high requirements on real-time performance, the second buffer may also adopt a form of a single buffer, and in an image rotation control process that has high requirements on real-time performance, the second buffer may also adopt more than three buffers.

Step 103: Read image data from the second buffer according to a second image format, so as to obtain a rotated second image.

When the first image format specifically is the Tile format and the second image format specifically is a Linear format, image data is read row by row in sequence from left to right from the second buffer according to the Linear format.

When the set second buffer in step 102 is formed of at least one pair of ping-pong buffers after one buffer in each pair of ping-pong buffers stores one column of Tile image blocks or one row of Tile image blocks of the first image, image data is read row by row in sequence from left to right from one buffer according to the Linear format. Furthermore, after the image data is read row by row in sequence from left to right from one buffer according to the Linear format, the buffer space of one buffer is released.

It can be seen from the foregoing embodiment that, through this embodiment, in a process of performing rotation control on an image, a read operation needs to be performed on the first buffer only once, so that the image data of the first image format is rotated to generate the image data of the second image format; therefore, compared with the prior art, in the rotation control process, the occupancy of system bandwidth in a terminal is reduced, other functional modules can obtain effective bandwidth in a situation that the bandwidth of the terminal is limited, and meanwhile the system power consumption is not wasted for increasing the system bandwidth.

An example of a process of rotating a Tile format image into a Linear format image is taken in the following to describe the embodiment of the image rotation control method of the present invention in detail, and to conveniently illustrate the Tile format and Linear format images, it is assumed that pixels of an image are 8*8.

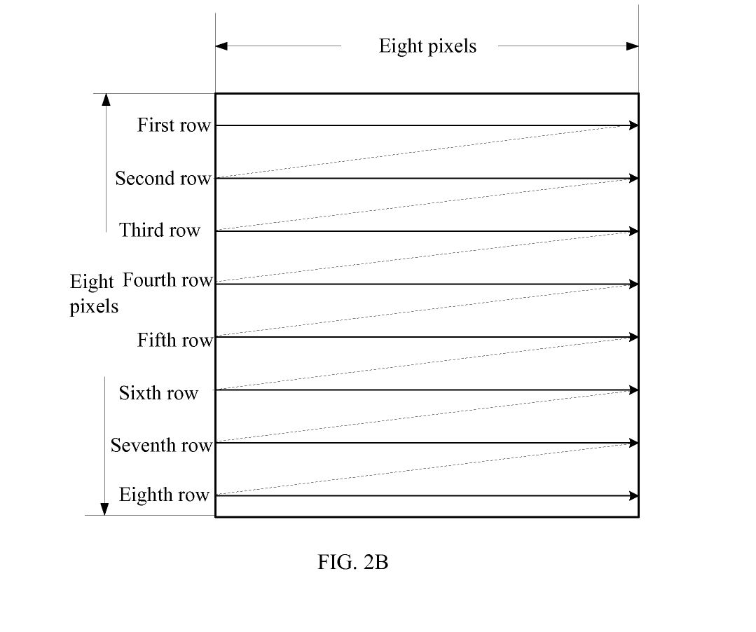

Referring to FIG. 2A, FIG. 2A is a schematic diagram of a Tile format image: When an image having pixels being 8*8 is in the Tile format, the image may be divided into four Tile image blocks, which are respectively marked as 1, 2, 3, and 4, and pixels of each Tile block are 4*4, that is, four rows and four columns, 16 pixels in total, the foregoing 16 pixels are numbered by consecutive addresses according to directions of arrows and dashed lines as shown in FIG. 2A, that is, an address of a last pixel of a row and that of a first pixel of a next row are continuous, and for two Tile blocks having numbers being adjacent to each other, an address of a last pixel of a former Tile block and that of a first pixel of a latter Tile block are continuous.

Referring to FIG. 2B, FIG. 2B is a schematic diagram of a Linear format image: Different from a Tile format image, for the Linear format, an image is not divided into blocks, instead the whole image is directly divided into rows, and addresses of pixels of each row are continuous, and row pixels are numbered by consecutive addresses according to directions of arrows and dashed lines as shown in FIG. 2B.

In the embodiment of the present invention, a Tile format image may be written into a rotation Buffer acting as the second buffer, and then a Linear format image is directly read from the rotation Buffer, that is, the image rotation is completed in one read/write process, and compared with an existing solution in which multiple read/write operations are performed multiple times to complete image rotation, the occupancy of system bandwidth can be reduced. The embodiment of the present invention is described in detail in the following by describing display rotation control processes in different rotation angles.

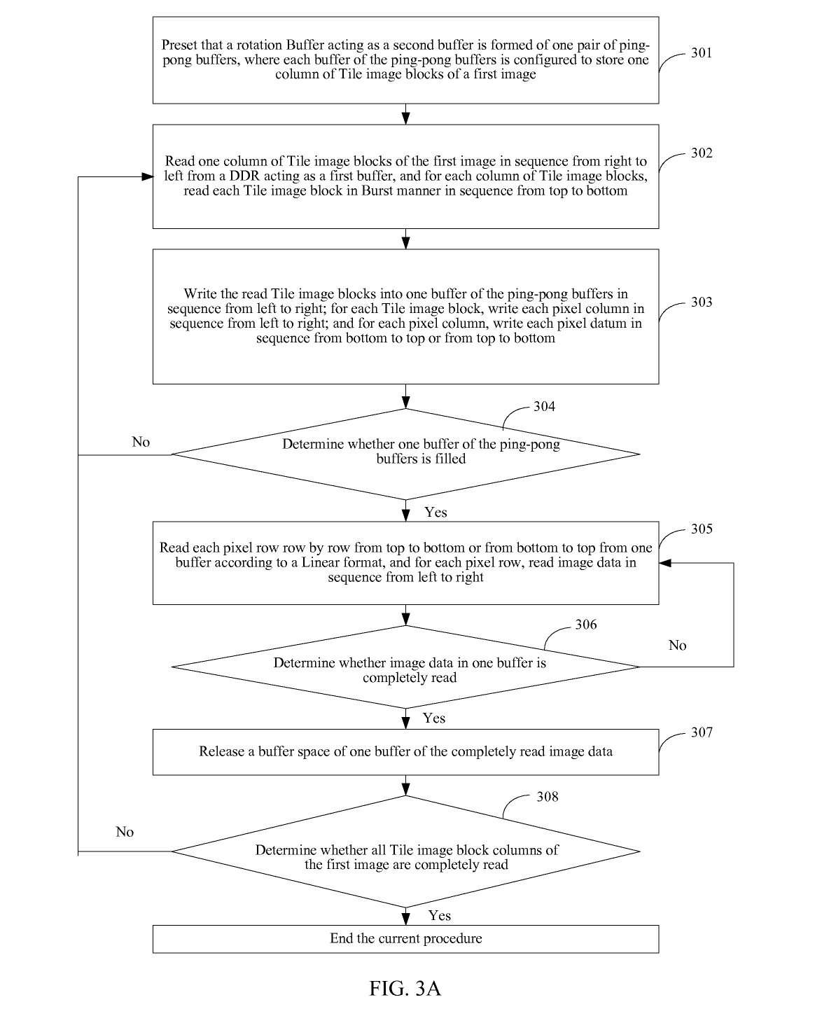

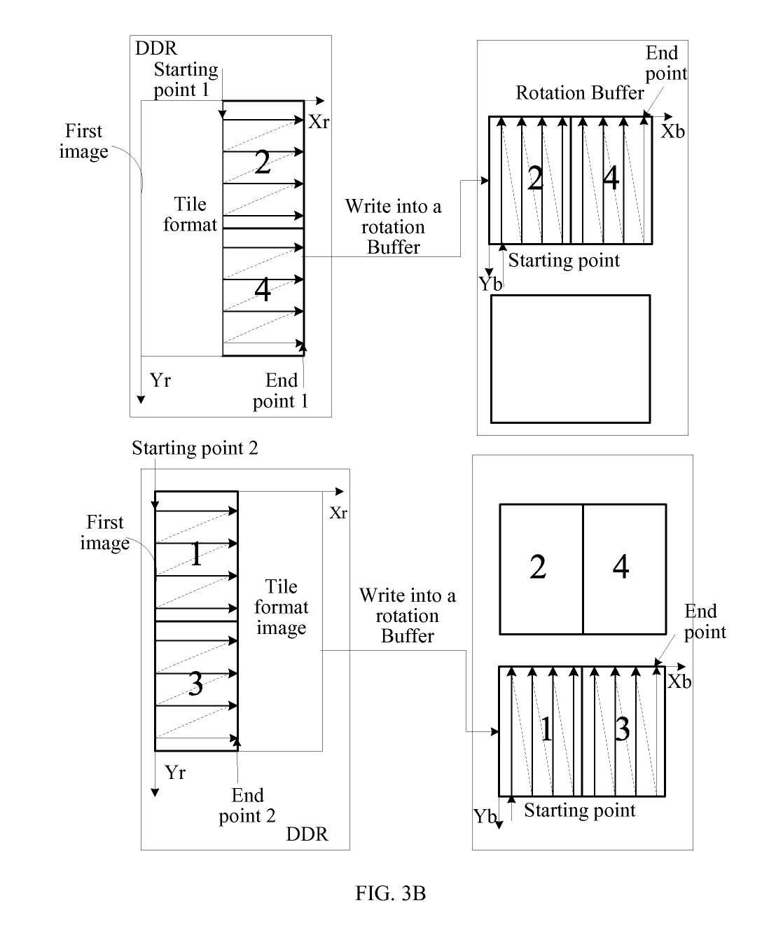

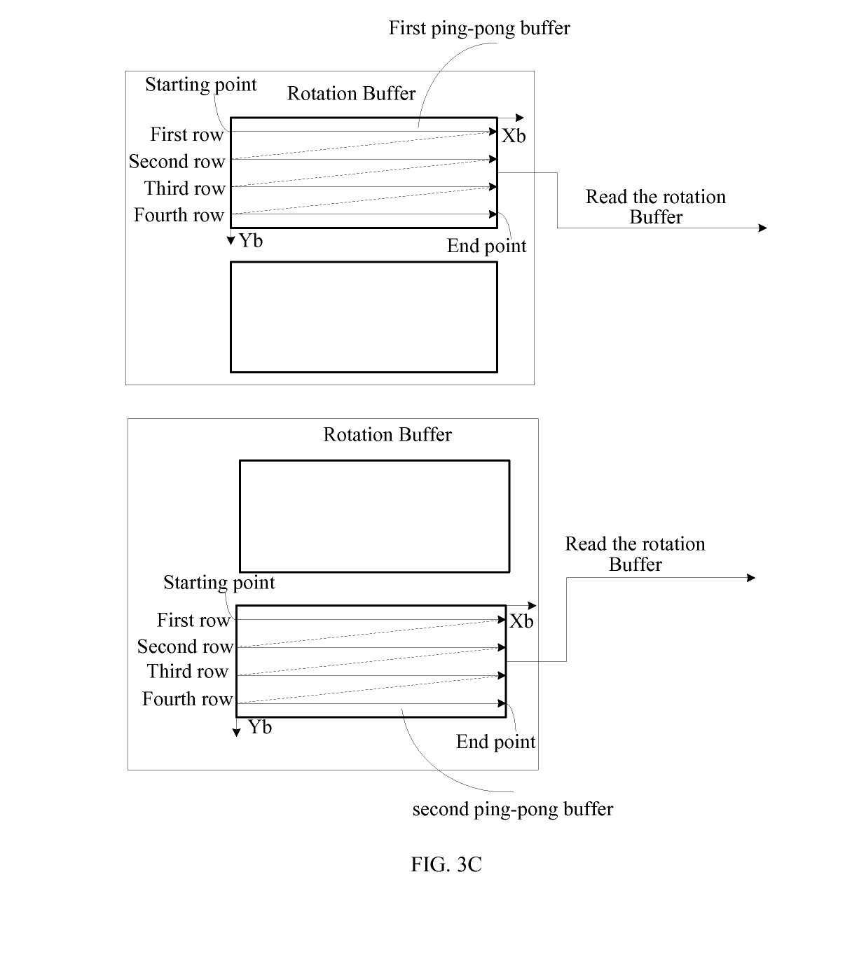

Referring to FIG. 3A, FIG. 3A is a flow chart of a second embodiment of an image rotation control method according to the present invention, and this embodiment shows a display control process when an image formed of four Tile image blocks is rotated by 90 degrees:

Step 301: Preset that a rotation Buffer acting as a second buffer is formed of one pair of ping-pong buffers, where each buffer of the ping-pong buffers is configured to store one column of Tile image blocks of a first image.

Step 302: Read one column of Tile image blocks of the first image in sequence from right to left from a DDR acting as a first buffer, and for each column of Tile image blocks, read each Tile image block in a Burst manner in sequence from top to bottom.

Step 303: Write the read Tile image blocks into one buffer of the ping-pong buffers in sequence from left to right; for each Tile image block, write each pixel column in sequence from left to right; and for each pixel column, write each pixel datum in sequence from bottom to top or from top to bottom.

Step 304: Determine whether one buffer of the ping-pong buffers is fully filled; if yes, execute step 305; otherwise, return to step 302.

Step 305: Read each pixel row row by row from top to bottom or from bottom to top from one buffer according to a Linear format, and for each pixel row, read image data in sequence from left to right.

When each pixel datum is written in sequence from bottom to top in step 303, in this step, each pixel row is read row by row from top to bottom, and for each pixel row, image data is read in sequence from left to right. When each pixel datum is written in sequence from top to bottom in step 303, in this step, each pixel row is read row by row from bottom to top, and for each pixel row, image data is read in sequence from left to right.

Step 306: Determine whether image data in one buffer is completely read; if yes, execute step 307; otherwise, return to step 305.

Step 307: Release a buffer space of one buffer of the completely read image data.

Step 308: Determine whether all Tile image block columns of the first image are completely read; if yes, end the current procedure; otherwise, return to step 302.

Referring to FIG. 3B, FIG. 3B is a schematic diagram of the process of reading Tile image blocks from a DDR and writing the Tile image blocks into a rotation Buffer in FIG. 3A:

As shown in FIG. 3B, the rotation Buffer acting as the second buffer is formed of one pair of ping-pong buffers, and the size of each buffer is consistent with the size of one column of Tile image blocks of the first image, and for the first image formed of four Tile image blocks, that is, each buffer is configured to store two Tile image blocks.

In FIG. 3B, a first column of Tile image blocks (including a Tile image block 2 and a Tile image block 4) and a second column of Tile image blocks (including a Tile image block 1 and a Tile image block 3) of the first image are read in sequence from right to left from the DDR acting as the first buffer. A read process of the first column of Tile image blocks is described in detail with reference to FIG. 3B: Starting from a first pixel (a starting point 1) of a first row of pixel data of the Tile image block 2, each pixel is read in sequence from left to right; after a last pixel of a fourth row of pixel data of the Tile image block 2 is read, starting from a first row of pixel data of the Tile image block 4, each pixel is read in sequence from left to right, and after the last pixel (an end point 1) of the fourth row of pixel data of the Tile image block 4 is read, reading the first column of Tile image blocks is completed.

After the first column of Tile image blocks is read, the read Tile image blocks are written into one buffer of the ping-pong buffers in sequence from left to right. A write process of the first column of Tile image blocks is described in detail with reference to FIG. 3B: For the read Tile image block 2, each pixel column of the Tile image block 2 is written in sequence from left to right, and for each pixel column, starting from the first pixel (the starting point) of the first pixel column, each pixel is written in sequence from bottom to top, and after the last pixel of the fourth column of pixel data of the Tile image block 2 is written, each pixel column of the Tile image block 4 is written in sequence from left to right, and for each pixel column, starting from the first pixel of the first pixel column, each pixel is written in sequence from bottom to top, and after the last pixel (the end point) of the fourth column of pixel data of the Tile image block 4 is written, a write operation of Tile image blocks in one buffer is completed.

Similarly, in FIG. 3B, a process of reading a second column of Tile image blocks from the DDR and writing the second column of Tile image blocks into the rotation Buffer is consistent with the read/write process of the foregoing first column of Tile image blocks, which is not described herein.

Referring to FIG. 3C, FIG. 3C is a schematic diagram of a process of reading a Linear format image from the rotation Buffer in FIG. 3B:

With reference to FIG. 3C, in the embodiment of the present invention, the image is rotated in the process of writing the Tile image blocks into the rotation Buffer and reading the Linear image from the rotation Buffer. For a first ping-pong buffer in the rotation Buffer in FIG. 3C, after two Tile image blocks (the Tile image block 2 and Tile image block 4) are filled in, image data may be read according to the Linear format, that is, image data in the first ping-pong buffer is divided into four rows, and reading the first ping-pong buffer is completed by reading from a first pixel (a starting point) of a first row of image data to a last pixel (an end point) of a fourth row of image data in sequence from left to right, and similarly, a process of reading image data from a second ping-pong buffer according to the Linear format is consistent with read process for the first ping-pong buffer, which is not described herein. After reading the image data in the foregoing two ping-pong buffers is completed, an image after the first image is rotated by 90 degrees is formed.

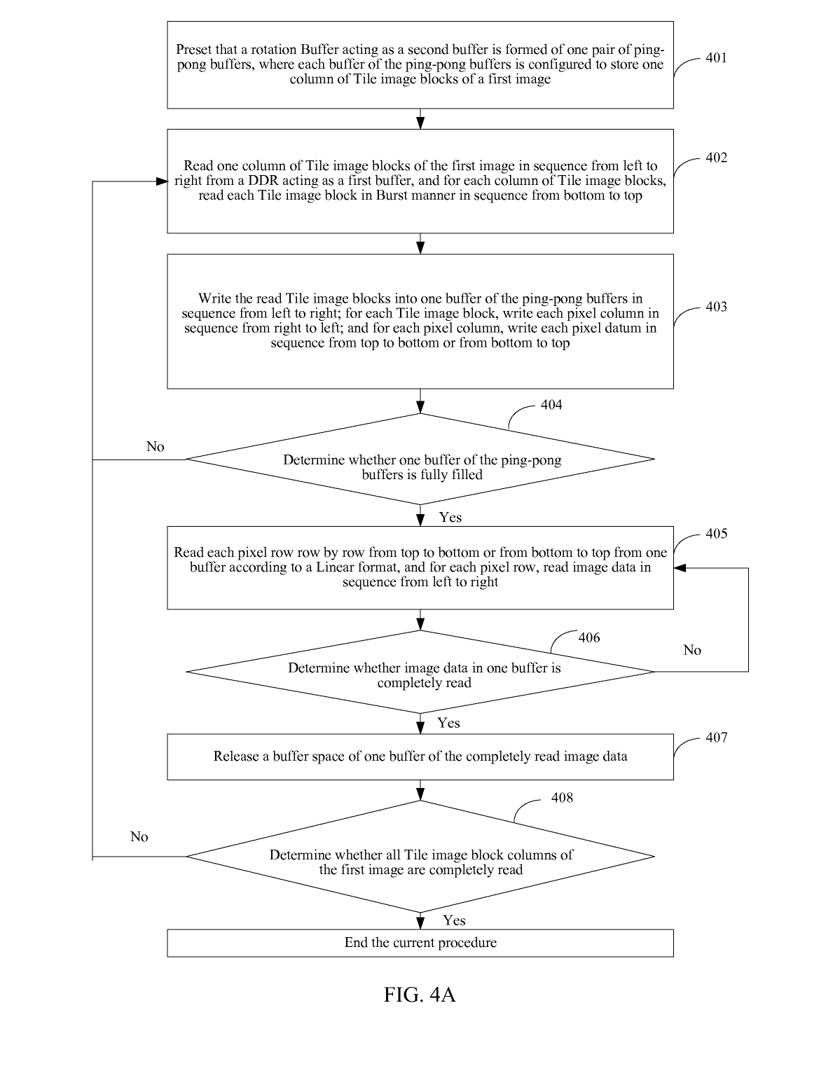

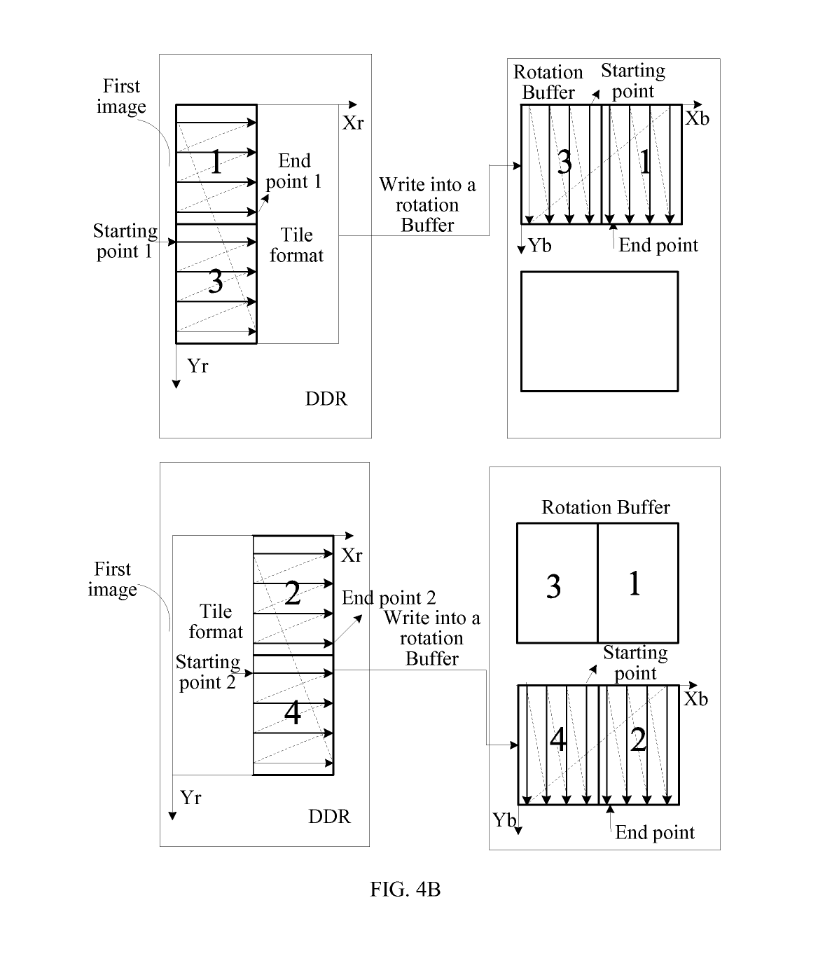

Referring to FIG. 4A, FIG. 4A is a flow chart of a third embodiment of an image rotation control method according to the present invention, and this embodiment shows a display control process when an image formed of four Tile image blocks is rotated by 270 degrees:

Step 401: Preset that a rotation Buffer acting as a second buffer is formed of one pair of ping-pong buffers, where each buffer of the ping-pong buffers is configured to store one column of Tile image blocks of a first image.

Step 402: Read one column of Tile image blocks of the first image in sequence from left to right from a DDR acting as a first buffer, and for each column of Tile image blocks, read each Tile image block in a Burst manner in sequence from bottom to top.

Step 403: Write the read Tile image blocks into one buffer of the ping-pong buffers in sequence from left to right; for each Tile image block, write each pixel column in sequence from right to left; and for each pixel column, write each pixel datum in sequence from top to bottom or from bottom to top.

Step 404: Determine whether one buffer of the ping-pong buffers is fully filled; if yes, execute step 405; otherwise, return to step 402.

Step 405: Read each pixel row row by row from top to bottom or from bottom to top from one buffer according to a Linear format, and for each pixel row, read image data in sequence from left to right.

When each pixel datum is written in sequence from top to bottom in step 403, in this step, each pixel row is read row by row from top to bottom, and for each pixel row, image data is read in sequence from left to right. When each pixel datum is written in sequence from bottom to top in step 403, in this step, each pixel row is read row by row from bottom to top, and for each pixel row, image data is read in sequence from left to right.

Step 406: Determine whether image data in one buffer is completely read; if yes, execute step 407; otherwise, return to step 405.

Step 407: Release a buffer space of one buffer of the completely read image data.

Step 408: Determine whether all Tile image block columns of the first image are completely read; if yes, end the procedure; otherwise, return to step 402.

Referring to FIG. 4B, FIG. 4B is a schematic diagram of a process of reading the Tile image blocks from the DDR and writing the Tile image blocks into the rotation Buffer in FIG. 4A:

As shown in FIG. 4B, the rotation Buffer acting as the second buffer is formed of one pair of ping-pong buffers, and the size of each buffer is consistent with the size of one column of Tile image blocks of the first image, and for the first image formed of four Tile image blocks, each buffer is configured to store two Tile image blocks.

In FIG. 4B, a first column of Tile image blocks (including a Tile image block 1 and a Tile image block 3) and a second column of Tile image blocks (including a Tile image block 2 and a Tile image block 4) of the first image are read from the DDR acting as the first buffer in sequence from left to right. A read process of the first column of Tile image blocks is described in detail with reference to FIG. 4B: Starting from a first pixel (a starting point 1) of a first row of pixel data of the Tile image block 3, each pixel is read in sequence from left to right; after a last pixel of a fourth row of pixel data of the Tile image block 3 is read, starting from a first row of pixel data of the Tile image block 1, each pixel is read in sequence from left to right; and after a last pixel (an end point 1) of a fourth row of pixel data of the Tile image block 1 is read, reading the first column of Tile image blocks is completed.

After the first column of Tile image blocks is read, the read Tile image blocks are written into one buffer of the ping-pong buffers in sequence from left to right. A write process of the first column of Tile image blocks is described in detail with reference to FIG. 4B: For the read Tile image block 3, each pixel column of the Tile image block 3 is written in sequence from right to left; for each pixel column, starting from the first pixel (the starting point) of the first pixel column, each pixel is written in sequence from top to bottom, and after the last pixel of the fourth column of pixel data of the Tile image block 3 is written, each pixel column of the Tile image block 1 is written in sequence from right to left; for each pixel column, starting from the first pixel of the first pixel column, each pixel is written in sequence from top to bottom, and after the last pixel (the end point) of the fourth column of pixel data of the Tile image block 1 is written, a write operation of Tile image blocks in one buffer is completed.

Similarly, in FIG. 4B, a process of reading a second column of Tile image blocks from the DDR and writing the second column of Tile image blocks into the rotation Buffer is consistent with the foregoing first column of Tile image blocks, which is not described herein.

A process of reading a Linear format image from the rotation Buffer in FIG. 4B is described with reference to FIG. 3C:

In the embodiment of the present invention, the image is rotated in the process of writing the Tile image blocks into the rotation Buffer and reading the Linear image from the rotation Buffer. For a first ping-pong buffer in the rotation Buffer in FIG. 3C, after two Tile image blocks (the Tile image block 1 and Tile image block 3) are filled in, image data may be read according to the Linear format, that is, image data in the first ping-pong buffer is divided into four rows, and reading the first ping-pong buffer is completed by reading from a first pixel (a starting point) of a first row of image data to a last pixel (an end point) of a fourth row of image data in sequence from left to right; and similarly, a process of reading image data from a second ping-pong buffer according to the Linear format is consistent with the first ping-pong buffer, which is not described herein. After the image data in the foregoing two ping-pong buffers is completely read, an image after the first image is rotated by 270 degrees is formed.

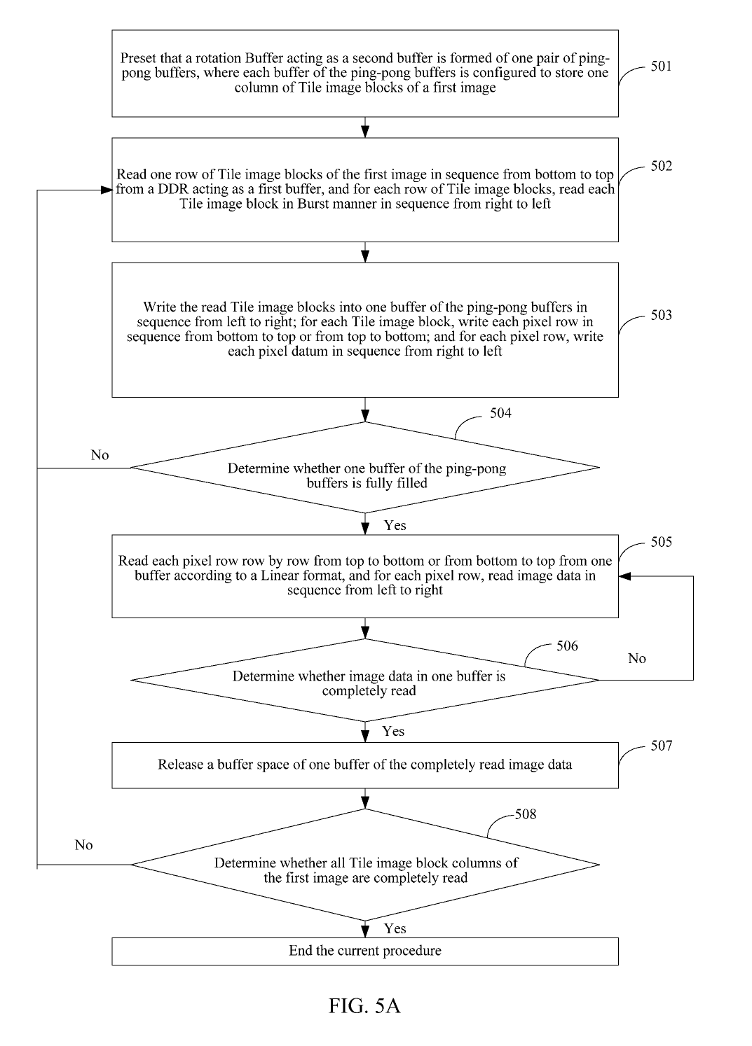

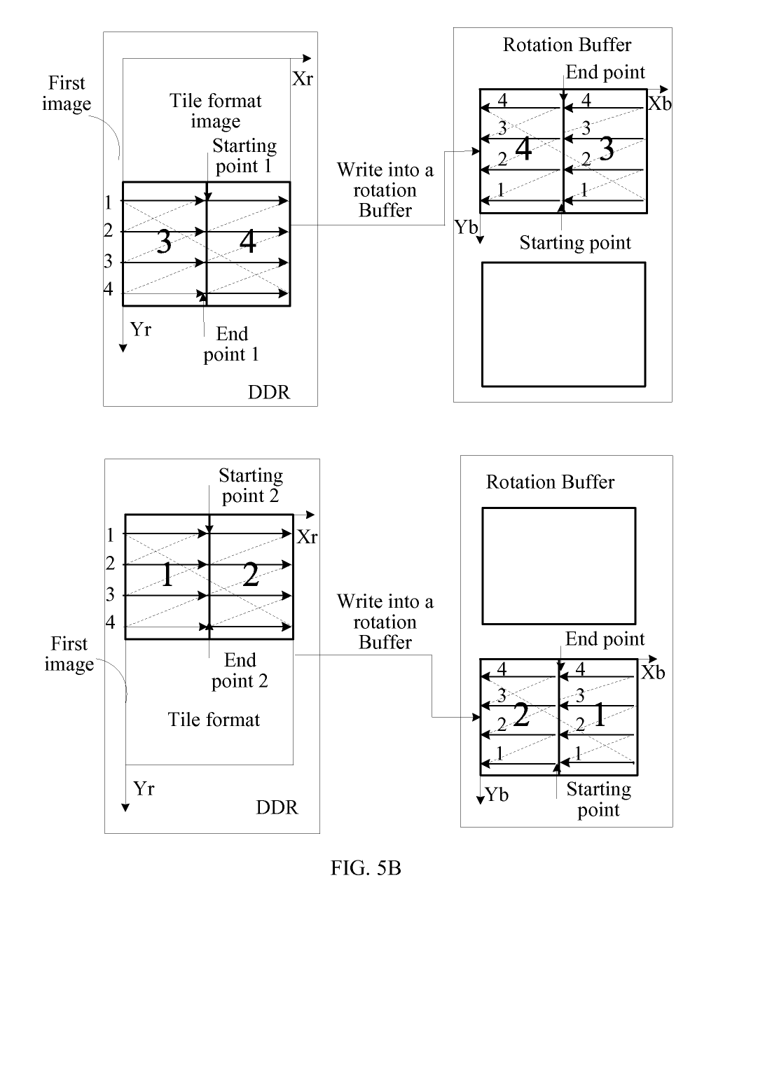

Referring to FIG. 5A, FIG. 5A is a flow chart of a fourth embodiment of an image rotation control method according to the present invention, and this embodiment shows a display control process when an image formed of four Tile image blocks is rotated by 180 degrees:

Step 501: Preset that a rotation Buffer acting as a second buffer is formed of one pair of ping-pong buffers, where each buffer of the ping-pong buffers is configured to store one column of Tile image blocks of a first image.

Step 502: Read one row of Tile image blocks of the first image in sequence from bottom to top from a DDR acting as a first buffer, and for each row of Tile image blocks, read each Tile image block in a Burst manner in sequence from right to left.

Step 503: Write the read Tile image blocks into one buffer of the ping-pong buffers in sequence from left to right; for each Tile image block, write each pixel row in sequence from bottom to top or from top to bottom; and for each pixel row, write each pixel datum in sequence from right to left.

Step 504: Determine whether one buffer of the ping-pong buffers is fully filled; if yes, execute step 505; otherwise, return to step 502.

Step 505: Read each pixel row row by row from top to bottom or from bottom to top from one buffer according to a Linear format, and for each pixel row, read image data in sequence from left to right.

When each pixel row is written in sequence from bottom to top in step 503, in this step, each pixel row is read row by row from top to bottom, and for each pixel row, image data is read in sequence from left to right. When each pixel row is written in sequence from top to bottom in step 503, in this step, each pixel row is read row by row from bottom to top, and for each pixel row, image data is read in sequence from left to right.

Step 506: Determine whether image data in one buffer is completely read; if yes, execute step 507; otherwise, return to step 505.

Step 507: Release a buffer space of one buffer of the completely read image data.

Step 508: Determine whether all Tile image block rows of the first image are completely read, if yes, end the procedure; otherwise, return to step 502.

Referring to FIG. 5B, FIG. 5B is a schematic diagram of the process of reading the Tile image blocks from the DDR and writing the Tile image blocks into the rotation Buffer in FIG. 5A:

As shown in FIG. 5B, the rotation Buffer acting as the second buffer is formed of one pair of ping-pong buffers, and the size of each buffer is consistent with the size of one row of Tile image blocks of the first image, and for the first image formed of four Tile image blocks, each buffer is configured to store two Tile image blocks.

In FIG. 5B, a first row of Tile image blocks (including a Tile image block 3 and a Tile image block 4) and a second row of Tile image blocks (including a Tile image block 1 and a Tile image block 2) of the first image are read from the DDR acting as the first buffer in sequence from bottom to top. A read process of the first row of Tile image blocks is described in detail with reference to FIG. 5B: Starting from a first pixel (a starting point 1) of a first row of pixel data of the Tile image block 4, each pixel is read in sequence from left to right; after a last pixel of a fourth row of pixel data of the Tile image block 4 is read, starting from a first row of pixel data of the Tile image block 3, each pixel is read in sequence from left to right; and after a last pixel (an end point 1) of a fourth row of pixel data of the Tile image block 3 is read, reading the first row of Tile image blocks is completed.

After the first row of Tile image blocks is read, the read Tile image blocks are written into one buffer of the ping-pong buffers in sequence from left to right. A write process of the first row of Tile image blocks is described in detail with reference to FIG. 5B: For the read Tile image block 4, each pixel row of Tile image block 4 is written in sequence from bottom to top; for each pixel row, starting from the first pixel (the starting point) of the first pixel row, each pixel is written in sequence from right to left; after the last pixel of the fourth row of pixel data of the Tile image block 4 is written, each pixel row of the Tile image block 3 is written in sequence from bottom to top, and for each pixel row, starting from the first pixel of the first pixel row, each pixel is written in sequence from right to left; and after the last pixel (the end point) of the fourth row of pixel data of the Tile image block 3 is written, a write operation of Tile image blocks in one buffer is completed.

Similarly, in FIG. 5B, a process of reading a second row of Tile image blocks from the DDR and writing the second row of Tile image blocks into the rotation Buffer is consistent with the foregoing first row of Tile image blocks, which is not described herein.

A process of reading a Linear format image from the rotation Buffer in FIG. 5B is described with reference to FIG. 3C:

In the embodiment of the present invention, the image is rotated in the process of writing the Tile image blocks into the rotation Buffer and reading the Linear image from the rotation Buffer. For a first ping-pong buffer in the rotation Buffer in FIG. 3C, after two Tile image blocks (the Tile image block 4 and Tile image block 3) are filled in, image data may be read according to the Linear format, that is, image data in the first ping-pong buffer is divided into four rows, and reading the first ping-pong buffer is completed by reading from a first pixel (a starting point) of a first row of image data to a last pixel (an end point) of a fourth row of image data in sequence from left to right; and similarly, a process of reading image data from a second ping-pong buffer according to the Linear format is consistent with the first ping-pong buffer, which is not described herein. After the image data in the foregoing two ping-pong buffers is completely read, an image after the first image is rotated by 180 degrees is formed.

Corresponding to the embodiments of the image rotation control method of the present invention, the present invention further provides an embodiment of an image rotation control device.

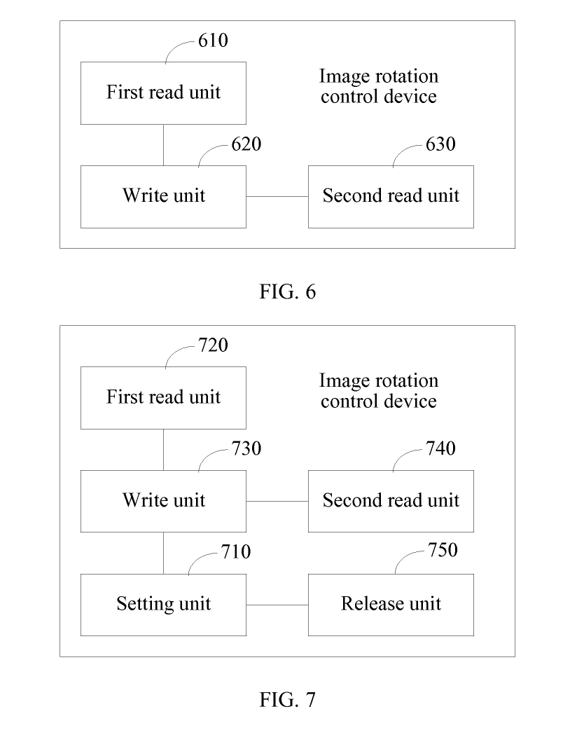

Referring to FIG. 6, FIG. 6 is a block diagram of a first embodiment of an image rotation control device according to the present invention:

The image rotation control device includes: a first read unit 610, a write unit 620, and a second read unit 630.

The first read unit 610 is configured to read image blocks of a first image from a first buffer according to a rotation angle, where the first image is in a first image format; and the first read unit 610 may be further specifically configured to: according to the rotation angle, read at least one column of image blocks or one row of image blocks of the first image from the first buffer each time.

The write unit 620 is configured to write the read image blocks into a preset second buffer.

The second read unit 630 is configured to read image data from the second buffer according to a second image format, so as to obtain a rotated second image.

When the first image format is a Tile format and the second image format is a Linear format, the first read unit 610 is specifically configured to read Tile image blocks of the first image from the first buffer in a burst transmission Burst manner in sequence according to the rotation angle; the write unit 620 is specifically configured to write the read Tile image blocks into the second buffer in sequence from left to right; and the second read unit 630 is specifically configured to read image data row by row in sequence from left to right from the second buffer according to the Linear format.

Specifically, the first read unit 610 may include (not shown in FIG. 6):
a rotating-by-90-degree read subunit, configured to read one column of Tile image blocks of the first image in sequence from right to left, and for each column of Tile image blocks, read each Tile image block in a burst transmission manner in sequence from top to bottom;
a rotating-by-270-degree read subunit, configured to read one column of Tile image blocks of the first image in sequence from left to right, and for each column of Tile image blocks, read each Tile image block in a burst transmission manner in sequence from bottom to top; and
a rotating-by-180-degree read subunit, configured to read one row of Tile image blocks of the first image in sequence from bottom to top, and for each row of Tile image blocks, read each Tile image block in a burst transmission manner in sequence from right to left.

Correspondingly, the write unit 620 may include (not shown in FIG. 6):
a rotating-by-90-degree write subunit, configured to write the Tile image blocks read by the rotating-by-90-degree read subunit into one buffer of the ping-pong buffers in sequence from left to right; for each Tile image block, write each pixel column in sequence from left to right; and for each pixel column, write each pixel datum in sequence from bottom to top or from top to bottom;
a rotating-by-270-degree write subunit, configured to write the read Tile image blocks into one buffer of the ping-pong buffers in sequence from left to right; for each Tile image block, write each pixel column in sequence from right to left; and for each pixel column, write each pixel datum in sequence from top to bottom or from bottom to top; and
a rotating-by-180-degree write subunit, configured to write the read Tile image blocks into one buffer of the ping-pong buffers in sequence from left to right; for each Tile image block, write each pixel row in sequence from bottom to top or from top to bottom; and for each pixel row, write each pixel datum in sequence from right to left.

Referring to FIG. 7, FIG. 7 is a block diagram of a second embodiment of an image rotation control device according to the present invention:

The image rotation control device includes: a setting unit 710, a first read unit 720, a write unit 730, a second read unit 740, and a release unit 750.

The setting unit 710 is configured to preset that a second buffer is formed of at least one pair of ping-pong buffers, where each buffer of each pair of ping-pong buffers is configured to store one column of Tile image blocks or one row of Tile image blocks of the first image.

The first read unit 720 is configured to read Tile image blocks of the first image from the first buffer in a burst transmission Burst manner in sequence according to a rotation angle.

The write unit 730 is configured to write the read Tile image blocks into one buffer of the pair of ping-pong buffers in sequence from left to right.

The second read unit 740 is configured to: after one buffer of the each pair of ping-pong buffers stores one column of Tile image blocks or one row of Tile image blocks of the first image, read each pixel row row by row from top to bottom or from bottom to top from the buffer according to a Linear format, and for each pixel row, read image data in sequence from left to right.

The release unit 750 is configured to: after the second read unit 740 reads each pixel row row by row from top to bottom or from bottom to top from the buffer according to the Linear format, and for pixel row, reads image data in sequence from left to right, release a buffer space of the buffer.

It should be noted that, in the embodiment of the present invention, the image rotation control device may be one part of a terminal display device, and may also be integrated in other devices of the terminal. After obtaining the rotated second image, the image rotation control device may input the second image to a display screen for output display after performing other processing on the second image.

It can be known from the foregoing embodiments that, in the embodiments of the present invention, the image blocks of the first image in the first image format are read from the first buffer according to a rotation angle, the read image blocks are written into the preset second buffer, and the image data is read from the second buffer according to the second image format, so as to obtain the rotated second image. According to the embodiments of the present invention, in a process of performing rotation control on an image, a read operation needs to be performed on the first buffer only once, so that the image data of the first image format is rotated to generate the image data of the second image format; therefore, compared with the prior art, in the rotation control process, the occupancy of system bandwidth in a terminal is reduced, other functional modules can obtain effective bandwidth in a situation that the bandwidth of the terminal is limited, and meanwhile the system power consumption is not wasted for increasing the system bandwidth.

Persons skilled in the art may clearly understand that, the technique in the embodiments of the present invention may be implemented through software and a necessary general hardware platform. Based on such an understanding, the technical solutions in the embodiments of the present invention essentially, or the part contributing to the prior art may be implemented in the form of a software product. The computer software product is stored in a storage medium, such as an ROM/RAM, a magnetic disk, or an optical disk, and includes several instructions for instructing a computer device (which may be personal computer, a server, or a network device) to perform the methods described in the embodiments of the present invention or in some parts of the embodiments of the present invention.

Each embodiment in the specification is described in a progressive manner. The same or similar parts in the embodiments are just references to each other. Every embodiment illustrates in emphasis what is different from the other embodiments. In particular, for the system embodiment, since it is basically similar to the method embodiment, the apparatus embodiment is described simply, and the relevant part may be obtained with reference to the part of the description of the method embodiment.

The foregoing descriptions are the embodiments of the present invention, but are not intended to limit the protection scope of the present invention. Any modifications, equivalent replacements and improvements made within the spirit and principle of the present invention shall fall within the protection scope of the present invention.

1. An image rotation control method, comprising:
reading image blocks of a first image from a first buffer according to a rotation angle, wherein the first image is in a first image format;
writing the read image blocks into a second buffer; and
reading image data from the second buffer according to a second image format, so as to obtain a rotated image.

2. The method according to claim 1, wherein:
the first image format is a Tile format, and the second image format is a Linear format;
the reading the image blocks of the first image from the first buffer according to the rotation angle comprises reading Tile image blocks of the first image from the first buffer in a burst transmission manner in sequence according to the rotation angle;
the writing the read image blocks into the second buffer comprises writing the read Tile image blocks into the second buffer in sequence from left to right; and
the reading the image data from the second buffer according to the second image format comprises reading the image data row-by-row in sequence from left to right from the second buffer according to the Linear format.

3. The method according to claim 2, wherein when the rotation angle is 90 degrees,
the reading the Tile image blocks of the first image from the first buffer in a burst transmission manner in sequence according to the rotation angle comprises:
reading one column of Tile image blocks of the first image in sequence from right to left; and
for each column of Tile image blocks, reading each Tile image block in a burst transmission manner in sequence from top to bottom; and
the writing the read Tile image blocks into the second buffer in sequence from left to right comprises:
writing the read Tile image blocks into one buffer of ping-pong buffers in sequence from left to right;
for each Tile image block, writing each pixel column in sequence from left to right; and
for each pixel column, writing each pixel datum in sequence from bottom to top or from top to bottom.

4. The method according to claim 2, wherein when the rotation angle is 270 degrees,
the reading Tile image blocks of the first image from the first buffer in a burst transmission manner in sequence according to the rotation angle comprises:
reading one column of Tile image blocks of the first image in sequence from left to right; and
for each column of Tile image blocks, reading each Tile image block in sequence from bottom to top in a burst transmission manner; and
the writing the read Tile image blocks into the second buffer in sequence from left to right comprises:
writing the read Tile image blocks into one buffer of ping-pong buffers in sequence from left to right;
for each Tile image block, writing each pixel column in sequence from right to left; and
for each pixel column, writing each pixel datum in sequence from top to bottom or from bottom to top.

5. The method according to claim 2, wherein when the rotation angle is 180 degrees,
the reading Tile image blocks of the first image from the first buffer in a burst transmission manner in sequence according to the rotation angle comprises:
reading one row of Tile image blocks of the first image in sequence from bottom to top; and
for each row of Tile image blocks, reading each Tile image block in a burst transmission manner in sequence from right to left; and
the writing the read Tile image blocks into the second buffer from left to right comprises:
writing the read Tile image blocks into one buffer of ping-pong buffers in sequence from left to right;
for each Tile image block, writing each pixel row in sequence from bottom to top or from top to bottom; and
for each pixel row, writing each pixel datum in sequence from right to left.

6. The method according to claim 2, further comprising:
presetting that the second buffer is formed of at least one pair of ping-pong buffers, wherein each buffer in the at least one pair of ping-pong buffers is configured to store one column of Tile image blocks or one row of Tile image blocks of the first image;
wherein the reading the image data row-by-row in sequence from left to right from the second buffer according to the Linear format comprises, after one buffer of the at least one pair of ping-pong buffers stores one column of Tile image blocks or one row of Tile image blocks of the first image, reading each pixel row row-by-row from top to bottom or from bottom to top from the second buffer according to the Linear format, and for each pixel row, reading image data in sequence from left to right.

7. The method according to claim 6, further comprising:
after reading each pixel row row-by-row from top to bottom or from bottom to top from the second buffer according to the Linear format, and for each pixel row, reading image data in sequence from left to right, releasing a buffer space of the second buffer.

8. The method according to claim 1, wherein the reading the image blocks of the first image from the first buffer according to the rotation angle comprises reading at least one column of image blocks or one row of image blocks of the first image from the first buffer each time according to the rotation angle.

9. An image rotation control device, comprising:
a first read unit, configured to read image blocks of a first image from a first buffer according to a rotation angle, wherein the first image is in a first image format;
a write unit, configured to write the image blocks read from the first read unit into a preset second buffer; and
a second read unit, configured to read image data from the second buffer according to a second image format, so as to obtain a rotated image.

10. The device according to claim 9, wherein:
the first image format is a Tile format and the second image format is a Linear format;
the first read unit is configured to read Tile image blocks of the first image from the first buffer in a burst transmission manner in sequence according to the rotation angle;
the write unit is configured to write the read Tile image blocks into the second buffer in sequence from left to right; and
the second read unit is configured to read the image data row-by-row in sequence from left to right from the second buffer according to the Linear format.

11. The device according to claim 10, wherein:
the first read unit comprises a rotating-by-90-degree read subunit, configured to:
read one column of Tile image blocks of the first image in sequence from right to left; and
for each column of Tile image blocks, read each Tile image block in a burst transmission manner in sequence from top to bottom; and
the write unit comprises a rotating-by-90-degree write subunit, configured to:
write the Tile image blocks read by the rotating-by-90-degree read subunit into one buffer of ping-pong buffers in sequence from left to right;
for each Tile image block, write each pixel column in sequence from left to right; and
for each pixel column, write each pixel datum in sequence from bottom to top or from top to bottom.

12. The device according to claim 10, wherein:
the first read unit comprises a rotating-by-270-degree read subunit, configured to:
read one column of Tile image blocks of the first image in sequence from left to right; and
for each column of Tile image blocks, read each Tile image block in a burst transmission manner in sequence from bottom to top; and
the write unit comprises a rotating-by-270-degree write subunit, configured to:
write the read Tile image blocks into one buffer of ping-pong buffers in sequence from left to right;
for each Tile image block, write each pixel column in sequence from right to left; and
for each pixel column, write each pixel datum in sequence from top to bottom or from bottom to top.

13. The device according to claim 10, wherein:
the first read unit comprises a rotating-by-180-degree read subunit, configured to:
read one row of Tile image blocks of the first image in sequence from bottom to top; and
for each row of Tile image blocks, read each Tile image block in a burst transmission manner in sequence from right to left; and
the write unit comprises a rotating-by-180-degree write subunit, configured to:
write the read Tile image blocks into one buffer of ping-pong buffers in sequence from left to right;
for each Tile image block, write each pixel row in sequence from bottom to top or from top to bottom; and
for each pixel row, write each pixel datum in sequence from right to left.

14. The device according to claim 10, further comprising:
a setting unit, configured to preset that the second buffer is formed of at least one pair of ping-pong buffers, wherein each buffer in the at least one pair of ping-pong buffers is configured to store one column of Tile image blocks or one row of Tile image blocks of the first image;
wherein the second read unit is configured to, after one buffer of the at least one pair of ping-pong buffers stores one column of Tile image blocks or one row of Tile image blocks of the first image, read each pixel row row-by-row from top to bottom or from bottom to top from the second buffer according to the Linear format, and for each pixel row, read image data in sequence from left to right.

15. The device according to claim 14, further comprising:
a release unit, configured to, after the second read unit reads each pixel row row-by-row from top to bottom or from bottom to top from the second buffer according to the Linear format, and for pixel row, read image data in sequence from left to right, release a buffer space of the second buffer.

16. The device according to claim 9, wherein the first read unit is configured to, according to the rotation angle, read at least one column of image blocks or one row of image blocks of the first image from the first buffer each time.
